(19) United States
(12) Patent Application Publication
(10) Pub. No.: US 2023/0297737 A1
(43) Pub. Date: Sep. 21, 2023

(54) MODELLING AN OBJECT, DETERMINATION OF LOAD CAPACITY, IMPROVEMENT OF THE DESIGN AND GENERATING COMPONENT, AND SYSTEM

(71) Applicant: Siemens Industry Software NV, Leuven (BE)

(72) Inventors: Hadrien Beriot, Le Vesinet (FR); Thijs Van Putten, Hallaar (BE); Flavien Boussuge, Rambouillet (FR)

(21) Appl. No.: 18/122,794

(22) Filed: Mar. 17, 2023

(30) Foreign Application Priority Data
Mar. 17, 2022 (EP) 22162686.4

(51) Int. Cl. G06F 30/23; G06F 30/17; G06T 17/20

(52) U.S. Cl. CPC G06F 30/23; G06F 30/17; G06T 17/20; G06F 2111/10

(57) ABSTRACT

A computer-implemented method for modelling an object subjected to boundary conditions from an object model that defines a component by a three-dimensional boundary representing format is provided. The method includes providing boundary conditions including loads and/or constraints to the object, and providing the object model. The boundary representation of the object model is tessellated, obtaining an object tessellation. An approximate convex decomposition is applied to the object tessellation, obtaining three-dimensional cells respectively defined from each other by splitting planes. A numerical model is generated by applying a discontinuous Galerkin method to the three-dimensional cells. Determination of a load capacity, an improvement of the design, or the generation, in each case, of the component, are provided.

This application claims the benefit of European Patent Application No. EP 22162686.4, filed on Mar. 17, 2022, which is hereby incorporated by reference in its entirety.

### FIELD

The present embodiments relate to a computer-implemented method for modelling an object subjected to boundary conditions from a three-dimensional object model.

Understanding how a component or product assembly reacts under stress, vibration, or thermal constraints is critical in any industry. Simple linear-statics analysis may, for example, be performed to calculate the structural response due to external forces, and evaluate whether displacement and deformation are acceptable for the product of interest. As products and materials become increasingly complex, engineers require more advanced simulation tools. Nowadays, the numerical approximation of Partial Differential Equations (PDEs) for Mechanical Analysis is predominantly addressed with Finite Element Analysis (FEA), owing to its robustness and generality. Software vendors typically consolidate analysis tools for different applications into a Computer-Aided Engineering (CAE) software suite that offers both structural and other performance analysis. The CAE suite leverages design information from the Computer-Aided Design (CAD) phase, and the CAE model may be updated when CAD design changes are made. Accordingly, Engineering departments in industry may use a single user interface to address structural and other performance calculations of interest.

### BACKGROUND

Finite Element Analysis (FEA) breaks the CAD-CAE integration because of the necessary meshing operation: (1) In FEA, the model size is dictated by the smallest geometrical details, and for the model to remain tractable, the geometry is first idealized before meshing (defeaturing). CAD models often include multiple geometrical details (e.g., holes, chamfers, fillets, imprints) that i) are not necessarily relevant for the finite element simulation, ii) are very difficult to mesh, and iii) if the geometrical details may be meshed, create additional degrees of freedom, thereby hindering the performance of the method. As a result, the geometries are often simplified prior to the analysis.

(2) Analysts spend a large amount of time defeaturing and cleaning up the CAD geometry to be able to perform analysis. This geometrical defeaturing or idealization creates large non-automated pre-processing efforts that often dominate the analysis time, and breaks the integration between Computer-Aided Design (CAD) and Computer-Aided Engineering (CAE), by creating two different versions of the same design.

(3) The FEA simulation workflow is mesh-centric, instead of being CAD-centric.

The mesh-centric FEM-dominated paradigm is an obstacle to the spread of simulation for structural analysis because the broad mass of design engineers never want to become familiar with this detailed and specific analysis technique.

As opposed to classical finite element methods that rely on a globally continuous approximation space, another class of methods allows the basis to be discontinuous across the elements. These methods generally fall in the scope of the Discontinuous Galerkin methods (see, e.g., [Cockburn, Bernardo, George E. Karniadakis, and Chi-Wang Shu, “The development of discontinuous Galerkin methods,” Discontinuous Galerkin Methods, Springer, Berlin, Heidelberg, 2000. 3-50]).

The discontinuous Galerkin methods (often referred to as DG methods) are used for solving differential equations in hyperbolic, elliptic, parabolic, and mixed form problems. The discontinuous Galerkin methods combine features of the finite element and the finite volume framework (e.g., in electrodynamics, fluid mechanics, and plasma physics).

While these methods may be operated on conventional finite element meshes, and that is in fact how they are mostly employed in the literature, their discontinuous nature may in theory be exploited to relax the requirements on the geometry partitioning. With such a discontinuous basis, a mesh may be composed of polytopic elements with arbitrary polyhedral shape and which interfaces are not necessarily matching (e.g., with hanging nodes and edges). For example, in Antonietti et al. (e.g., [Antonietti, Paola F., et al., “Review of discontinuous Galerkin finite element methods for partial differential equations on complicated domains,” Building bridges: connections and challenges in modern approaches to numerical partial differential equations, Springer, Cham, 2016. 281-310]), the DG method is applied on meshes obtained from composite agglomeration of conventional finite elements. The advantage is that the resulting cells may then incorporate small geometric details, drastically reducing the pre-processing time. One important restriction for the construction of these elements is that their non-convexity remains marginal according to Cangiani et al. (e.g., [Cangiani, Andrea, et al., hp-Version discontinuous Galerkin methods on polygonal and polyhedral meshes, Springer, 2017]).

Another class of methods that may be applied on non-conventional geometry partitioning are the Trefftz methods, a method for the numerical solution of partial differential equations named after the German mathematician Erich Trefftz (1888-1937). An overview over the Trefftz methods is given in Eisuke et al. (e.g., [Kita, Eisuke, and Norio Kamiya, “Trefftz method: an overview,” Advances in Engineering software 24.1-3 (1995): 3-12]) and Qin et al. (e.g., [Qin, Q. H., 2005, Trefftz finite element method and its applications]).

In most Trefftz methods, the approximation space is also discontinuous across the elements. The shape functions are therefore different for every element and are constructed directly in the physical space (e.g., no mapping to a parent element). This theoretically allows the method to also operate “on arbitrarily shaped elements”, also incorporating some smaller geometrical features. The Trefftz methods have been successfully applied to solve: Elasticity (e.g., by Freitas et al. [(1) De Freitas, J. A. T. and Cismasiu, C., 2000, Developments with hybrid-Trefftz stress and displacement elements; (2) De Freitas, J. T. and Bussamra, F. L. S., 2000, Three-dimensional hybrid-Trefftz stress elements, International Journal for Numerical Methods in Engineering, 47(5), pp. 927-950]); thermal (e.g., by Qin et al. [Qin, Q. H., 2005, Trefftz finite element method and its applications]; stress-thermal (e.g., by Grysa et al. [Grysa, K. and Macia, g, A., 2011, Solving direct and inverse thermoelasticity problems by means of Trefftz base functions for finite element method, Journal of Thermal Stresses, 34(4), pp. 378-393]); elastoplastic (e.g., by De Freitas et al. [De Freitas, J. T. and Wang, Z. M., 1998, Hybrid-Trefftz stress elements for elastoplasticity, International Journal for Numerical Methods in Engineering, 43(4), pp. 655-683]); and acoustic problems (e.g., by Deckers et al. [Deckers, Elke, et al., “The wave based method: An overview of 15 years of research,” Wave Motion 51.4 (2014): 550-565]).

Their principle lies in handling physics-based shape functions, which verify exactly the governing equation. This in turn allows removing all volume integrals from the formulation according to Kita et al. (e.g., [Kita, E. and Kamiya, N., 1995, Trefftz method: an overview, Advances in Engineering software, 24(1-3), pp. 3-12]) and Herrera et al. (e.g., [Herrera, I., 2000, Trefftz method: a general theory, Numerical Methods for Partial Differential Equations: An International Journal, 16(6), pp. 561-580]). This absence of volume parametrization (e.g., only surfaces are needed for the discretization) is also beneficial to reduce the solver data requirements (e.g., no multi-million volume elements model is generated).

In Trefftz methods also, some geometrical restrictions apply on the elements, as it is difficult to construct an appropriate Trefftz basis on complex strongly concave configurations (see, e.g., Deckers et al. [as above] for acoustics or Sokolnikoff et al. [Sokolnikoff, Ivan Stephen, and Robert Dickerson Specht, Mathematical theory of elasticity, Vol. 83, New York: McGraw-Hill, 1956] for elasticity).

Currently, the industry standard to solve boundary value problems in the field of Computer-Aided Engineering [CAE] is the finite element method. The finite element method not only transforms continuous equations into discrete approximations but also requires that the domain considered be discretized. This discretization requires the simulation domain to be divided into a finite number of geometrically conforming elements. Taken as a whole, this set of elements and their connections form a finite element mesh. The shapes of the elements are limited to a few simple ones (e.g., polyhedra with 4, 5 or 6 faces (tetrahedrons, hexahedra, prisms, and pyramids) in three dimensions). The local solution within an element is approximated by piecewise polynomials. The finite element method is highly versatile and is routinely applied in many disciplines of engineering and science. Nowadays, many commercial software packages (e.g., the Siemens NX Nastran product [NX 2017]) implementing the finite element method are available. However, the cost and scalability of finite element-based technologies is bounded not only by the computation time but also (and often to a greater extent) by the time-consuming tasks of converting CAD assemblies (sometimes containing thousands of components) to idealized finite element mesh models. In practice, generating suitable meshes for high-fidelity CAD models faces many issues both during geometry preparation and mesh generation. Indeed, geometry preparation often contain excessive details (e.g., holes, chamfers, fillets, imprints) that impact the computational cost and that are not essential for FEM analysis. Hence, analysts spend a large amount of time defeaturing and cleaning up the CAD geometry to be able to perform analysis. This also breaks the CAD-CAE integration because the designers and finite element analysts end up working on different versions of the same design.

In contrast to conventional finite element methods, alternative approaches (e.g., referred to as “meshless” approaches) have been proposed by the simulation community to overcome the need to create an equivalent mesh model of a given CAD model. In “meshless” methods, the spatial domain is not discretized by elements, which consequently removes the need to clean/defeature the geometry. The full manufactured geometry (e.g., containing small geometric details) may be used during the resolution. Instead of generating a mesh, “fully meshless” approaches, such as the ones based on the moving point technique [Onate 1996], use scattered point distributed throughout the computation domain. Another interesting class of methods are the fictitious domain methods or CutFEM (e.g., [Duster 2008, Burman 2015]), in which the original, un-simplified geometry is immersed into a Cartesian grid that does not need to conform to the geometry. A special quadrature treatment is applied on the so-called immersed cells, which are partly inside and partly outside the geometry. The rest of the elements, not in contact with the boundaries of the geometry, are typically modeled using a classical Finite Element methodology. This approach may lead to efficient CAD-embedded approaches without needing to compute a conventional mesh of the geometry nor to defeature the conventional mesh of the geometry. One limitation is, however, the applications involving thin structures, such as metal or composite plates, which are omnipresent in CAE applications. There, an element size close to the thickness of the plate is to be used, which hinders the overall performance of the approach.

### SUMMARY AND DESCRIPTION

The scope of the present invention is defined solely by the appended claims and is not affected to any degree by the statements within this summary.

None of the prior art approaches provide a 3D-simulation capability that is fast, intuitive, and sufficiently accurate. More user-friendly facilitations of the present embodiments may be provided to achieve a mechanical analysis methodology and process that may be used by the wider design-engineers community, complementary to the existing FEA user base.

The present embodiments may obviate one or more of the drawbacks or limitations in the related art. For example, the problems identified with the prior art as explained above may be overcome or at least mitigated.

As another example, numerical simulation of engineering computer aided design (CAD) models may be performed directly on the original, without simplifying the geometry (e.g., CAD-embedded simulation).

As yet another example, not much user CAE-knowledge for performing CAE analysis may be required.

In accordance with the present embodiments, there is provided a solution for the above described problems by the incipiently defined method with the additional acts of: (c) tessellating a boundary representation of an object model, such that an object tessellation is obtained; (d) applying an approximate convex decomposition to the object tessellation, such that three-dimensional cells (3DC) respectively defined from each other by splitting planes are obtained; and (e) generating a numerical model by applying discontinuous Galerkin method to the three-dimensional cells.

The present embodiments further relate to the determination of the load capacity, the improvement of the design, or the generation, in each case, of the component.

The boundary conditions including loads and/or constraints may include static or dynamic effects. This enables the usage of the present embodiments for solving problems related to structural dynamics and/or thermal effects and/or acoustic effects and/or the field of Noise-Vibration-Harshness [NVH].

To conventionally solve differential equations through over the object, amending the object, the meshing and often other adjustments are necessary. These measures are time consuming. The present embodiments beneficially help to save these efforts.

According to the present embodiments, a three-dimensional boundary representing format may be a Computer-Aided Design Boundary Represented format (e.g., the .STEP format, a Standard for the Exchange of Product Data) or a tessellated mesh format (e.g., the .stl format).

The present embodiments intend to directly apply the boundary conditions (e.g., loads and constraints) of the boundary value problem on the Computer-Aided Design model or the tessellated model.

The present embodiments enable beneficially structural solver methodologies for non-CAE specialists: (1) The modelling according to the present embodiments may be done meshless, and operated directly on CAD and tessellated models; (2) The modelling according to the present embodiments is flexible and adaptive and may be done with automatic order (p) and/or mesh (h)—refinement; and (3) The modelling according to the present embodiments enables GPU parallelism to reach run times closer to minutes than hours.

The present embodiments enable a new modelling and simulation methodology and open these technologies to the wider community of design engineers. Engineers are enabled to assess their geometry structural performance in only a couple of minutes and without advanced CAE expertise. The present embodiments may only require a 3D simulation capability that is sufficiently performant to enable a fast, intuitive, and sufficiently accurate analysis result of the designed structure.

The present embodiments introduce a method for performing numerical simulation of engineering Computer-Aided Design models directly on the original geometry (CAD-embedded simulation). The present embodiments combine two techniques: i) the decomposition of the initial geometry into nearly convex sub-regions or “elements” using an Approximate Convex Decomposition (Approximate Convex Decomposition) algorithm; and ii) applying a discontinuous computational scheme (e.g., the Discontinuous Galerkin or the Trefftz Method, where Trefftz Discontinuous Galerkin (TDG) is considered to belong to Discontinuous Galerkin (DG) methods).

By applying a discontinuous computational scheme, the present embodiments solve an elliptic boundary value problem described by partial differential equations on the resulting non-conformal, polyhedral partitioning of the geometry.

The Approximate Convex Decomposition algorithm applied by the present embodiments is mainly applied for the automatic collision detection of objects in complex scenes developed for computer graphics enhancement. Fast and precise collision detection is important to achieve realistic animations in video games, virtual reality, and robotics, and a rich literature has been devoted to the topic [Weller 2013].

The present embodiments may apply a subclass of Approximate Convex Decomposition methods (e.g., the class of volumetric Approximate Convex Decomposition algorithms known from Mamou et al. —Mamou, K., Lengyel, E. and Peters, A. K., 2016, Volumetric hierarchical approximate convex decomposition, Game Engine Gems 3 (pp. 141-158)). The present embodiments apply this technology partly and deviates from its original purpose. Instead of collision avoidance in graphical animation, the present embodiments use Approximate Convex Decomposition for the pre-processing of geometries in Computer Aided Engineering.

The traditional output of volumetric Approximate Convex Decomposition is a set of convex hulls approximating the original geometry. As an intermediate step of the algorithm, a set of clipping planes are generated by the algorithm based on concavity, balance of volume, and possibly also symmetry criteria. In the context of the present embodiments, the clipping planes generated during the application of the Approximate Convex Decomposition methodology to this preliminary result is of particular interest.

These clipping planes, splitting planes, or simply ‘splitters’ may be extracted (e.g., represented by a set of plane equations in three dimensions). These splitting planes may be used to create a volumetric segmentation of the original geometry, generating subdomains, or three-dimensional cells respectively defined from each other by these splitting planes for generating a numerical model respectively for a subsequent numerical method (e.g., basically for solving the underlying three-dimensional given physical phenomenon, such as structural behavior, thermal transport, or wave propagation). Although of arbitrary shape, the concavity of the resulting polyhedral cells is sufficiently reduced (e.g., minimized), which makes the resulting polyhedral cells suitable candidates for numerical simulation, using a DG or Trefftz-based approach. This suppresses the need to mesh the object or to perform time-consuming idealizations or defeaturing geometric transformations prior to the analysis.

In other words, the method may include acts of: 1. Importing the three-dimensional object using a Computer-Aided Design Boundary Represented format (e.g., the .STEP format, a Standard for the Exchange of Product Data) or a tessellated mesh format (e.g., the .stl format) and applying the boundary conditions (e.g., loads and constraints) of the boundary value problem directly on the Computer-Aided Design model or the tessellated model; 2. Tessellating finely the object while, for example, keeping the geometrical error well controlled across the model; 3. Performing (acts of the) approximate convex decomposition (algorithm) to obtain bisection planes respectively the splitting planes. The tessellation of the object is then segmented respectively bisected using these splitters, and the model data structure is created, decomposing the object into three-dimensional cells. The method may also include acts of: 4. After this modelling, for determining the load capacity of said component, for example: solving the object model using a discontinuous finite element method (e.g., applying a discontinuous Galerkin method) or, for example, Trefftz, possibly adaptive, approach; and 5. —then, for example, post-processing on the initial object.

Applying approximate convex decomposition may preferably be continued until a convexity measure is obtained for—every object tessellation and/or—every three-dimensional cell fulfilling a predefined convexity threshold criterion. As a convexity measure any convexity estimator may be used as commonly used in the analysis of shape.

Another embodiment provides determining the load capacity of the component, which may include: (f) solving the numerical model by using a solver obtaining an analysis result including at least one parameter field of said component. The at least one parameter field of the component may include stress distribution, deformation geometry or displacement geometry, and/or mechanical safety margin of the component subjected to the boundary conditions. These analysis results are suitable to enable a strength assessment of the component and understand if amendments are necessary to adjust the component design to the load conditions.

Another embodiment provides improving the design of the component regarding load capacity criteria. This further enhancement includes: (g) comparing the analysis result with predefined set-intervals for the values of at least one of the parameter fields and changing the component and the object model according to predefined amendment rules to obtain an improved component design leading to an analysis result more likely within the predefined set-intervals when repeating acts (b)-(f).

In order to have efficient design improvement, the predefined amendment rules may provide adding or removing material or density or stiffness of locations of the component having values of at least one of the parameter fields that are not within the predefined set-intervals.

Another embodiment provides iterating or repeating the acts (b)— (g) until a predefined design criterion is met.

According to the present embodiments, further generating a component is provided according to a design determined according to the previous description.

The present embodiments further refer to a computer system arranged and configured to execute the acts of the computer-implemented method according to any combination of the above explained features and to a computer-readable medium encoded with such executable instructions, that when executed, cause the computer system to carry out such a method.

### BRIEF DESCRIPTION OF THE DRAWINGS

FIG. 1 shows a flow diagram of a method according to an embodiment.

### DETAILED DESCRIPTION

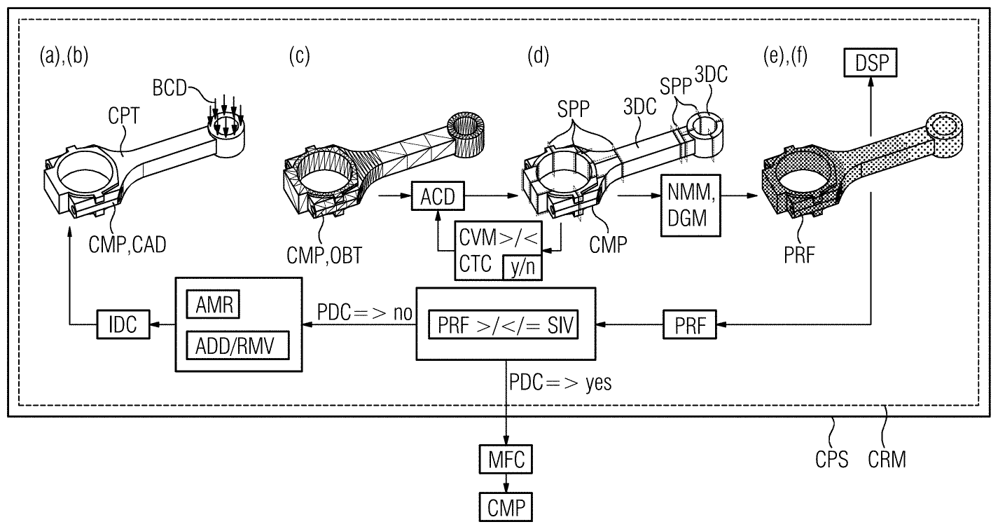

FIG. 1 shows a simplified flow diagram illustrating a computer-implemented method according to the present embodiments for modelling an object CPT subjected to boundary conditions BCD from a three-dimensional object model CAD. The method illustrated may be run on a computer system CPS arranged and configured to execute the acts of the computer-implemented method and may be handled using a computer-readable medium CRM encoded with executable instructions, that when executed, cause the computer system CPS to carry out the method.

The method provides that the object model CAD defines a component CMP by a three-dimensional boundary representing format BRF. Starting from that, a number of acts (a)-(g) are performed. As shown in FIG. 1, in act (a), boundary conditions BCD including loads and/or constraints to the object CPT are provided. In act (b), the object model CAD is provided. In act (c), the boundary representation of the object model CAD is tessellated, such that an object tessellation OBT is obtained. In act (d), an approximate convex decomposition ACD is applied to the object tessellation OBT, such that three-dimensional cells 3DC respectively defined from each other by splitting planes SPP) are obtained. The approximate convex decomposition ACD may be applied until a convexity measure CVM is obtained for every object tessellation OBT and/or every three-dimensional cell 3DC fulfills a predefined convexity threshold criterion CTC. In act (e), a numerical model NMM is generated by applying a discontinuous Galerkin method DGM to the three-dimensional cells 3DC. In act (f), for determining the load capacity of a component CMP, the numerical model NMM is solved by using a solver SLV obtaining an analysis result ANR including at least one parameter field PRF of the component CMP: stress distribution SDT, deformation geometry DFG or displacement geometry DPG, and/or mechanical safety margin MSM of the component CMP subjected to the boundary conditions BCD. In one embodiment, at least the resulting parameter fields PRF or other analysis results ANR may be shown to a user for verification (e.g., via a display DSP). In act (g), for improving the design of the component CMP regarding load capacity criteria, the method provides comparing the analysis result ANR with predefined set-intervals SIV for the values of at least one of the parameter fields PRF and changing the component CMP and the object model CAD according to predefined amendment rules AMR to obtain an improved component design ICD leading to an analysis result ANR more likely within the predefined set-intervals SIV when repeating acts b-f.

This iteration or repetition of acts b-g may be done until a predefined design criterion PDC is met.

The predefined amendment rules AMR may provide adding ADD or removing RMV material or density or stiffness of locations of the component CMP having values of at least one of the parameter fields PRF that are not within the predefined set-intervals SIV.

Finally, a component CMP may be generated by manufacturing MFC the component CMP according to the improved component design ICD.

While the present disclosure has been described in detail with reference to certain embodiments, the present disclosure is not limited to those embodiments. In view of the present disclosure, many modifications and variations would present themselves, to those skilled in the art without departing from the scope of the various embodiments of the present disclosure, as described herein. The scope of the present disclosure is, therefore, indicated by the following claims rather than by the foregoing description. All changes, modifications, and variations coming within the meaning and range of equivalency of the claims are to be considered within the scope.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

1. A method for modelling an object subjected to boundary conditions from a three-dimensional (3D) object model, wherein the 3D object model defines a component by a 3D boundary representing format, the method being computer-implemented and comprising:
providing the boundary conditions, which include loads, constraints, or loads and constraints, to the object;
providing the 3D object model;
tessellating a boundary representation of the 3D object model, such that an object tessellation is obtained;
applying an approximate convex decomposition to the object tessellation, such that 3D cells respectively defined from each other by splitting planes are obtained; and
generating a numerical model, the generating of the numerical model comprising applying a discontinuous Galerkin method to the 3D cells.

2. The method of claim 1, wherein the approximate convex decomposition is applied until a convexity measure is obtained for every object tessellation, every three-dimensional cell, or every object tessellation and every three-dimensional cell, fulfilling a predefined convexity threshold criterion.

3. The method of claim 1, further comprising determining a load capacity of the component, the determining of the load capacity of the component comprising:
solving the numerical model using a solver, such that an analysis result comprising at least one parameter field of the component is obtained, the at least one parameter field comprising stress distribution, deformation geometry or displacement geometry, mechanical safety margin, or any combination thereof of the component subjected to the boundary conditions.

4. The method of claim 3, further comprising improving design of the component regarding load capacity criteria, the improving of the design of the component regarding load capacity criteria comprising:
comparing the analysis result with predefined set-intervals for values of one or more parameter fields of the at least one parameter field; and
changing the component and the object model according to predefined amendment rules, such that an improved component design leading to an analysis result more likely within the predefined set-intervals when repeating the providing, the tessellating, the applying, the generating, and the solving is obtained.

5. The method of claim 4, wherein the predefined amendment rules provide adding or removing material, density, or stiffness of locations of the component having values of at least one of the parameter fields that are not within the predefined set-intervals.

6. The method of claim 4, wherein the providing, the tessellating, the applying, the generating, the solving, the comparing, and the changing are repeated until a predefined design criterion is met.

7. The method of claim 4, further comprising:
generating the component, the generating of the component comprising:
manufacturing the component according to the improved component design.

8. A computer system comprising:
a processor configured to:
model an object subjected to boundary conditions from a three-dimensional (3D) object model, wherein the 3D object model defines a component by a 3D boundary representing format, the modeling of the object comprising:
provision of the boundary conditions, which include loads, constraints, or loads and constraints, to the object;
provision of the 3D object model;
tessellation of a boundary representation of the 3D object model, such that an object tessellation is obtained;
application of an approximate convex decomposition to the object tessellation, such that 3D cells respectively defined from each other by splitting planes are obtained; and
generation of a numerical model, the generation of the numerical model comprising application of a discontinuous Galerkin method to the 3D cells.

9. In a non-transitory computer-readable storage medium that stores instructions executable by one or more processors to model an object subjected to boundary conditions from a three-dimensional (3D) object model, wherein the 3D object model defines a component by a 3D boundary representing format, the instructions being comprising:
providing the boundary conditions, which include loads, constraints, or loads and constraints, to the object;
providing the 3D object model;
tessellating a boundary representation of the 3D object model, such that an object tessellation is obtained;
applying an approximate convex decomposition to the object tessellation, such that 3D cells respectively defined from each other by splitting planes are obtained; and
generating a numerical model, the generating of the numerical model comprising applying a discontinuous Galerkin method to the 3D cells.

10. The non-transitory computer-readable storage medium of claim 9, wherein the approximate convex decomposition is applied until a convexity measure is obtained for every object tessellation, every three-dimensional cell, or every object tessellation and every three-dimensional cell, fulfilling a predefined convexity threshold criterion.

11. The non-transitory computer-readable storage medium of claim 9, wherein the instructions further comprise determining a load capacity of the component, the determining of the load capacity of the component comprising:
solving the numerical model using a solver, such that an analysis result comprising at least one parameter field of the component is obtained, the at least one parameter field comprising stress distribution, deformation geometry or displacement geometry, mechanical safety margin, or any combination thereof of the component subjected to the boundary conditions.

12. The non-transitory computer-readable storage medium of claim 11, wherein the instructions further comprise improving design of the component regarding load capacity criteria, the improving of the design of the component regarding load capacity criteria comprising:
comparing the analysis result with predefined set-intervals for values of one or more parameter fields of the at least one parameter field; and
changing the component and the object model according to predefined amendment rules, such that an improved component design leading to an analysis result more likely within the predefined set-intervals when repeating the providing, the tessellating, the applying, the generating, and the solving is obtained.

13. The non-transitory computer-readable storage medium of claim 12, wherein the predefined amendment rules provide adding or removing material, density, or stiffness of locations of the component having values of at least one of the parameter fields that are not within the predefined set-intervals.

14. The non-transitory computer-readable storage medium of claim 12, wherein the providing, the tessellating, the applying, the generating, the solving, the comparing, and the changing are repeated until a predefined design criterion is met.

15. The non-transitory computer-readable storage medium of claim 12, wherein the instructions further comprise:
generating the component, the generating of the component comprising:
manufacturing the component according to the improved component design.
